(19) United States
(12) Patent Application Publication
(10) Pub. No.: US 2005/0252531 A1
(43) Pub. Date: Nov. 17, 2005

(54) Method for loosening and fragmenting scale from the inside of pipes

(76) Inventor: Torstein Landaas, Stavanger (NO)

Correspondence Address: CHRISTIAN D. ABEL, ONSAGERS AS, POSTBOKS 6963 ST. OLAVS PLASS, NORWAY, N-0130, NO

(21) Appl. No.: 10/502,569

(22) PCT Filed: Jan. 30, 2003
(86) PCT No.: PCT/NO03/00028

§ 371 Date: Sep. 21, 2004

(51) Int. Cl. B08B 9/00

(52) U.S. Cl. 134/22.11; 134/22.12; 134/34

(57) ABSTRACT

The invention relates to a method for loosening and fragmenting scale (2) from the inside of particularly long and/or bent pipelines with pipe (1), characterized in that:—a line/cable (4) is blown through the pipe (1) with a gas flow (3) under pressure, in that the friction between the gas flow (3) and the length of the line/cable (4) results in a rapid transport of the line/cable (4) through the pipe (1),—a nozzle head (6) connected to a hose (7) for supplying water under high pressure is attached to the outer end of the line/cable (4),—the line cable (4) is pulled back while the water spouting from the nozzle head under pressure, forming at least a water jet (8), cuts up and crushes the scale (2) into fragments (2′), said fragments (2′) then being fluidised in the gas flow (3), where the water jet (8) after purging forms an aerosol fog which is mixed in with the gas flow (3) forming a three-phase regime,—the supplied gas is transported out through the pipe (1).

The invention relates to a method for loosening and fragmenting scale from the inside of particularly long and/or bent pipelines like those in smelting plants, refineries and oil terminals, which may involve continuous pipe lengths of 20 km, and where for various reasons the pipes are arranged with relatively tight bends.

Pipe cleaning is based mainly on two technologies: chemical cleaning and high-pressure jet water washing.

Intensive use of most chemicals for this purpose poses a risk of harming the environment and personnel, and clear restrictions are imposed on the use of chemicals, often including a ban on discharging chemicals into the environment.

High-pressure jet water washing is a cheap, efficient and eco-friendly method of cleaning, which involves using a nozzle head, preferably with one or more rear-pointing nozzles providing forward thrust of the nozzle head and hose while at the same time removing scale from the inside wall of the pipe. The scale is transported out of the pipe with the water flow or by pulling back on the purging hose. The weight of the purging hose places a restriction on the length and complexity of the cleaning unit because of bends, and vertical pipes are more difficult to clean because one is working against gravity. Also pipe systems with height variations make expulsion of removed scale difficult because the scale has to be transported on an incline, where the nozzles have insufficient thrust for said purpose. Frequently the water volume is increased for more effective expulsion of removed scale, which may pose several problems, depending on availability of water and pollution from removed scale.

“Standard two-phase methods” refers to fluid mechanics, which involves the flow of gas and liquid in pipes. In this case, both liquid and gas are referred to as phases. Fluid mechanics describes which flow regime you get with different velocities of liquid and gas, and the relationship between those two elements. With an annular flow the fluid/gas ratio is 1:10 and with an aerosol fog flow it is 1:100.

“Reynolds number” describes the relationship between the kinetic energy and the friction work, both per unit of volume, in a flowing gas or fluid. If the Reynolds number exceeds a certain critical value, turbulence occurs, i.e. the flow changes from laminar to turbulent flow along with a manifold increase in friction. When the velocity of the fluid and gas is high, turbulent flow is achieved, which is optimal for cleaning pipe walls, because its velocity profile corresponds to uniform velocity throughout the pipe, as opposed to laminar flow, where the highest velocity is in the centre of the pipe and low velocity along the pipe walls.

The following is cited from patent literature:
EP 0 490 117 A1 describes a procedure for cleaning a pipeline with the aid of a two-phased flow based on a chemical liquid and gas, achieving an internal helical annular-flowing travel through the pipe, attuned according to the fluid's density, surface tension, viscosity and given velocity, where the procedure allows a gas/liquid mix ratio of 3,000 to 7,500 m³:1 m³ or 2.0 to 6.0 kg:1 kg. The apparatus for carrying out the procedure is based on a source of pressurized gas for blowing the gas flow through a supply line supplied with liquid from a separate source at an angle of 45° to the pipeline axis.
U.S. Pat. Nos. 5,169,454, 5,538,025 and 5,051,135 describe devices for cleaning objects in a closed chamber with permanently installed nozzles.

This application concerns a method for loosening and fragmenting scale from the inside of particularly long and/or bent pipelines with pipes.

The method is characterized by the following:
a line/cable is blown through the pipe with a gas flow under pressure, in that the friction between the gas flow and the length of the line/cable results in a rapid transport of the line/cable through the pipe,
a nozzle head connected to a hose for supplying water under high pressure is attached to the outer end of the line/cable,
the line/cable is pulled back as the water spouting from the nozzle head under pressure to form at least a water jet, cuts through and crushes the scale into fragments, said fragments then being fluidised in the gas flow where, after purging, the water jet forms an aerosol fog which is mixed in with the gas flow to form a three-phase regime,
the supplied gas is transported out through the pipe.

In various alternative embodiments, the gas can be transported out through the pipe in a direction opposite to that in which the nozzle head is pulled. Furthermore, the nozzle head is pulled in at a velocity determined by the scale type and thickness as well as the dimension of the pipe, while the scale removal is in progress. Alternatively, the scale can be removed by pulling in the hose with nozzle head to the desired position and then increasing the purging.

The pressurized gas can be compressed air.

The line/cable can be coiled up on a drum, which can be driven by a drive arrangement or disengaged for pulling out or releasing the line/cable, respectively. Alternatively, the line/cable can be wound up onto some other suitable arrangement or wound into a loose coil.

The nozzle head may be fixed or rotating. The nozzle head may also have front slanting or rear slanting water jets. A preferred arrangement, which yields a good effect, is a nozzle head with two front slanting and two rear slanting water jets.

The fluidised three-phase regime with scale fragments is easy to clean in the preferred arrangement, in that the velocity of the gas is reduced, causing the scale fragments (2′) to precipitate by virtue of their own weight. This is preferred because it is simple and precise. Furthermore, the fluidised three-phase regime with scale fragments after cleaning is separated so that the water can be reused.

The various embodiments of the invention will be further detailed through the examples shown in the enclosed figures, where:

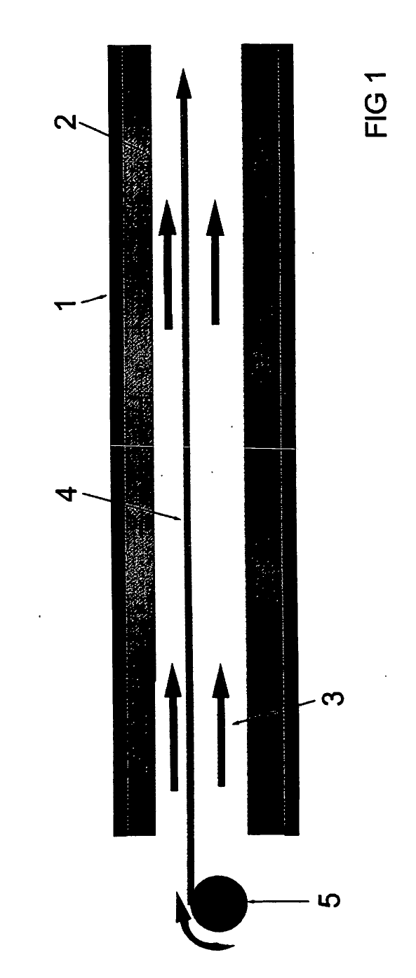

FIG. 1, in a cross section of the longitudinal axis, shows a pipe with internal scale where a cable is blown in according to this invention;

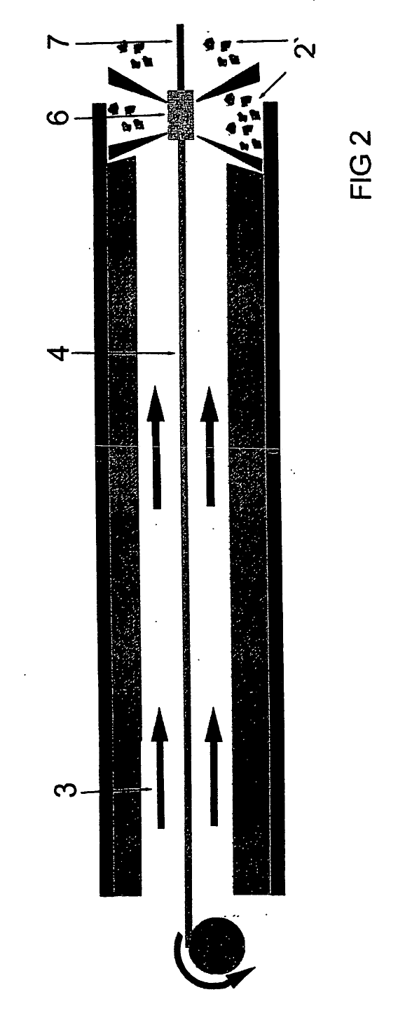

FIG. 2 shows the next step of the method according to this invention, following that which is shown in FIG. 1;

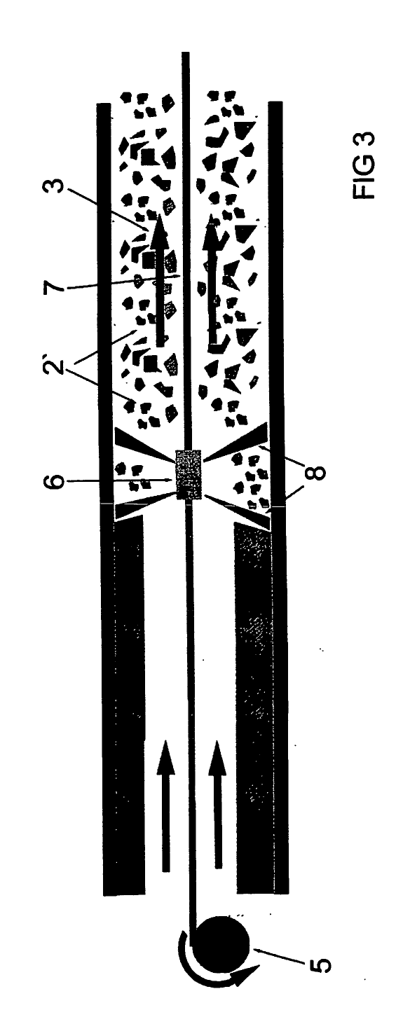

FIG. 3 shows the next step of the method according to this invention, following that which is shown in FIG. 2, where the nozzle head cleans the inside of the pipe;

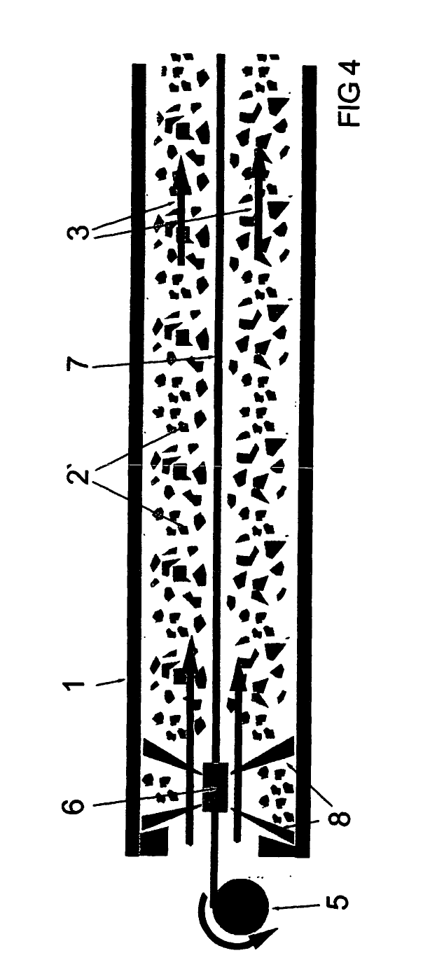

FIG. 4 shows the final part of the pipe cleaning operation, where the fragmented scale is transported through the pipe;

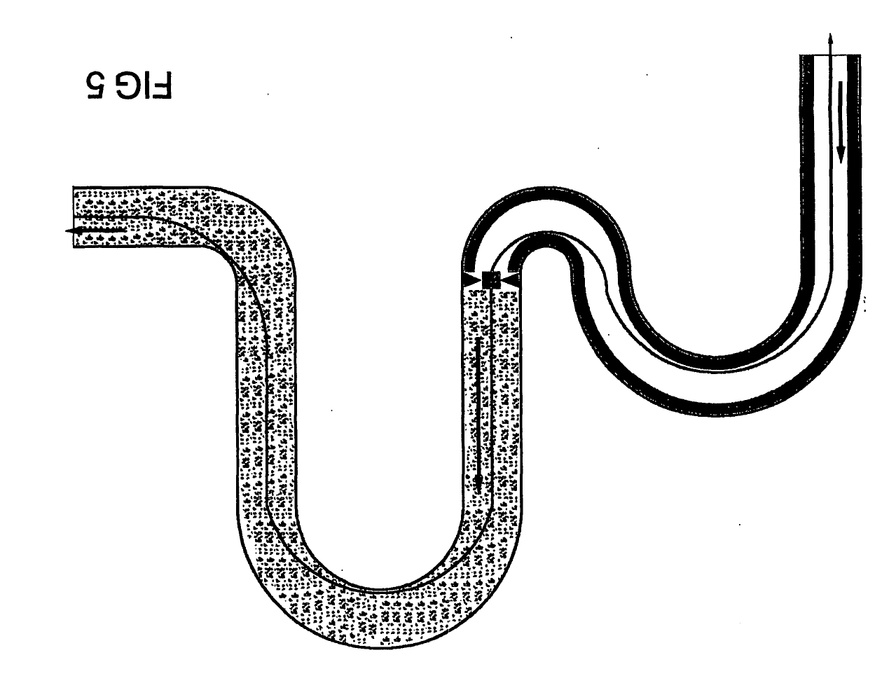

FIG. 5 shows an embodiment where the pipe is sharply curved.

FIG. 1 shows how a line/cable 4 is blown through a pipe 1 with internal scale 2, with the aid of pressurized gas 3 such as compressed air. The line is unwound preferably from a motorized drum 5, the drum being disengaged and turning freely during unwinding. Alternatively, other constructions may be employed for holding the line, or the line can be wound up into a loose coil. The friction between the flow of pressurized gas 3 and the length of the wire/rope 4 entails a rapid shift of the line/cable 4 over particularly long distances such as more than 20 km, and through very difficult and multi-angled pipelines.

FIG. 2 shows how the line/cable 4 is attached to a, e.g., rotating nozzle head 6 connected to a hose 7 for supplying water under high pressure to produce four water jets from the nozzle head 6, two front slanting and two rear slanting water jets 8, which cut up and crush scale 2 into fragments 2′, which are fluidised in the gas flow 3. After the processing phase the water jet 8 will act as an aerosol fog, which is mixed in with the gas flow. The line/cable 4 is wound up, e.g., on the drum 5 at a speed depending on the type and thickness of the scale, and when the nozzle head 6 is pulled axially through the pipe 1, both a rotated as well as a non-rotated nozzle head 6 will remain self-centred because of the balanced recoil effect of the two pairs of water jets. The nozzle head's other characteristics such as diameter, number of water jets and their angle out from the nozzle head, even or variable sharpness of the water jets, etc., depend primarily on the task, i.e. type and thickness of the scale and pipe dimension.

FIG. 3 shows how the nozzle head 6 with hose 7 for water supply is pulled in the direction of the drum 5 as the scale is converted into fluidised fragments 2′ and moves in and with the gas flow with aerosol fog, in a three-phase regime away from the processing area for the water jets 8 from the nozzle head 6.

FIG. 4 shows a pipe 1 the cleaning of which is near completion, where the nozzle head 6 is pulled almost all the way up to the drum 5, where the fluidised fragments 2′ are still flowing in and along with the gas flow, but where, after completed processing, the pipe will be blown clean of fragments 2′, also in long and difficult pipelines.

FIG. 5 shows, as a supplement, how the procedure described above can be carried out in a difficult, bent pipeline, where the fluidised three-phase regime will bring the loosened scale fragments 2′ out of the pipe and away from the processing area.

Available air/gas volumes are generated from a compressor unit powered by, e.g., an electric motor.

The invention is based on using air pumps for transporting fragments through pipe systems and at the same time removing loosened scale. This is achieved by connecting an air/gas pump to the pipe system. You first blow through a line/cable, which is then connected to the high-pressure hose with the nozzle head, after which the nozzles are activated and the line/cable can be pulled through the pipe. Because of the velocity of the gas being pumped through, it has sufficient friction energy to transport the scale fragments in horizontal and vertical pipe systems with many bends. Gas, such as air, not water, is used to transport the loosened scale, and after the processing phase the relatively modest amount of water consumed in the nozzles acts as an aerosol fog, which is mixed in with the gas flow, forming a three-phase regime.

After cleaning is completed, the fluidised three-phase regime with scale fragments can be returned to a gas-and-fluid/solids expansion separator with a large cross section, which entails that the air loses velocity and hence its ability transport the fragments and the water, which because of their relatively high weight will then sink to the bottom of the separator for collection/drainage, where the water can then be reused.

1. Method for loosening and fragmenting scale (2) from the inside of particularly long and/or bent pipelines with pipe (1), characterized in that:
a line/cable (4) is blown through the pipe (1) with a gas flow (3) under pressure, in that the friction between the gas flow (3) and the length of the line/cable (4) results in a rapid transport of the line/cable (4) through the pipe (1),
a nozzle head (6) connected to a hose (7) for supplying water under high pressure is attached to the outer end of the line/cable (4),
the line/cable (4) is pulled back while the water spouting from the nozzle head under pressure to form at least a water jet (8) cuts up and crushes the scale (2) into fragments (2′), said fragments (2′) then being fluidised in the gas flow (3), where the water jet (8) after purging forms an aerosol fog which is mixed into the gas flow (3) forming a three-phase regime,
the supplied gas is transported out through the pipe (1).

2. Method according to claim 1, characterized in that the gas is transported out through the pipe in a direction opposite to that in which the nozzle head (6) is pulled.

3. Method according to one or more of the above claims, characterized in that the nozzle head (6) with line/cable (4) is pulled in at a speed determined by the scale (2) type, thickness and dimension of the pipe (1) while the scale removal operation is in progress.

4. Method according to one or more of the above claims, characterized in that the scale is removed by pulling in the hose (7) with nozzle head (6) to a desired position, after which the purging increases.

5. Method according to one or more of the above claims, characterized in that the pressurized gas is compressed air.

6. Method according to one or more of the above claims, characterized in that the line/cable is wound up on a drum (5), which can be driven by a drive arrangement or disengaged for pulling back or releasing the line/cable, respectively.

7. Method according to one or more of the above claims, characterized in that the nozzle head is rotating.

8. Method according to one or more of the above claims, characterized in that the nozzle head is fixed.

9. Method according to one of the claims, 7 or 8, characterized in that the nozzle head spouts front slanting and rear slanting water jets (8).

10. Method according to claim 9, characterized in that the nozzle head spouts four water jets, two front slanting and two rear slanting jets (8).

11. Method according to one or more of the above claims, characterized in that the fluidised three-phase regime with scale fragments (2′) is cleaned by reducing the velocity of the gas so that the scale fragments (2′) precipitate because of their weight.

12. Method according to claim 11, characterized in that the fluidised three-phase regime with scale fragments (2′) after cleaning is separated for reuse of water.
